(19) United States
(12) Patent Application Publication
(10) Pub. No.: US 2026/0087849 A1
(43) Pub. Date: Mar. 26, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventor: HIDENORI AOKI, TOKYO (JP)

(21) Appl. No.: 19/112,607

(22) PCT Filed: Sep. 12, 2023
(86) PCT No.: PCT/JP2023/033138

§ 371 Date: Mar. 18, 2025

(30) Foreign Application Priority Data
Sep. 26, 2022 (JP) 2022-152175

(51) Int. Cl. G06V 40/16; G06V 40/18; G10L 21/013; H04L 12/18

(52) U.S. Cl. CPC G06V 40/174; G06V 40/161; G06V 40/171; G06V 40/18; G10L 21/013; H04L 12/1822

(57) ABSTRACT

The present technology relates to an information processing apparatus capable of appropriately evaluating a degree of dominance of a participant participating in an online conversation such as a video-chat, depending not only on an utterance amount, an information processing method, and a program. A degree of dominance of a participant in a conversation is estimated on the basis of a face image of the participant participating in the conversation. The present technology can be applied to a video-chat or the like using a terminal such as a smartphone.

### TECHNICAL FIELD

The present technology relates to an information processing apparatus, an information processing method, and a program, and more particularly, to an information processing apparatus capable of appropriately evaluating a degree of dominance of a participant participating in a conversation, depending not only on an amount of utterance, an information processing method, and a program.

### BACKGROUND ART

Patent Document 1 discloses a technique for appropriately transmitting information in a situation where a user's hand cannot be specified. Specifically, Patent Document 1 discloses a technique involving a display device that can be mounted on the head, such as a head mounted display, and an imaging unit that can image the lips and the eyes, in which word identification and expression recognition from a captured image are performed on the basis of movement of the lips, and associated stamps are transmitted from the result. Patent Document 2 discloses a technique by which voice data of a speech uttered by a user is stored in advance, and an utterance is recognized on the basis of a video image captured by imaging a motion of the lips of the user, and a technique for creating a speech using text of the utterance recognized by the utterance recognition and the stored voice data. Patent Document 3 discloses a technique for estimating a degree of satisfaction in a conversation among a plurality of persons.

### CITATION LIST

### Patent Document

Patent Document 1: Japanese Patent Application Laid-Open No. 2021-157681

Patent Document 2: Japanese Patent Application Laid-Open No. 2019-208138

Patent Document 3: Japanese Patent Application Laid-Open No. 2018-169506

### SUMMARY OF THE INVENTION

### Problems to be Solved by the Invention

In a conversation (online chat) such as a video-chat, even in a case where the user is not speaking, there may be a situation where the user is regarded as participating in the conversation as if the user were speaking. Therefore, the degree of dominance of a participant participating in a conversation cannot be appropriately evaluated only from the utterance amount (the time ratio of the utterance).

The present technology has been made in view of such circumstances, and aim to be capable of appropriately evaluating the degree of dominance of a participant participating in a conversation, depending not only on an utterance amount.

### Solutions to Problems

An information processing apparatus or a program according to the present technology is an information processing apparatus including a processing unit that estimates a degree of dominance of a participant in a conversation on the basis of a face image of the participant participating in the conversation, or a program for causing a computer to function as such an information processing apparatus.

An information processing method according to the present technology is an information processing method by which a processing unit of an information processing method including the processing unit estimates a degree of dominance of a participant in a conversation, on the basis of a face image of the participant participating in the conversation.

In the information processing apparatus, the information processing method, and the program according to the present technology, the degree of dominance of a participant in a conversation is estimated on the basis of a face image of the participant participating in the conversation.

### BRIEF DESCRIPTION OF DRAWINGS

FIG. 1 is a block diagram illustrating an example configuration of an information processing system according to an embodiment to which the present technology is applied.

FIG. 2 is a view used for explaining detection of facial landmarks.

FIG. 3 is a view used for explaining detection of facial landmarks.

FIG. 4 is a diagram illustrating an example of an action correspondence table.

FIG. 5 is a flowchart illustrating an example of the processing procedures to be carried out by the information processing apparatus in FIG. 1.

FIG. 6 is a block diagram illustrating an example configuration of an embodiment of a computer to which the present technology is applied.

### MODE FOR CARRYING OUT THE INVENTION

In the description below, an embodiment of the present technology will be explained with reference to the drawings.

### Data Processing System According to the Present Embodiment

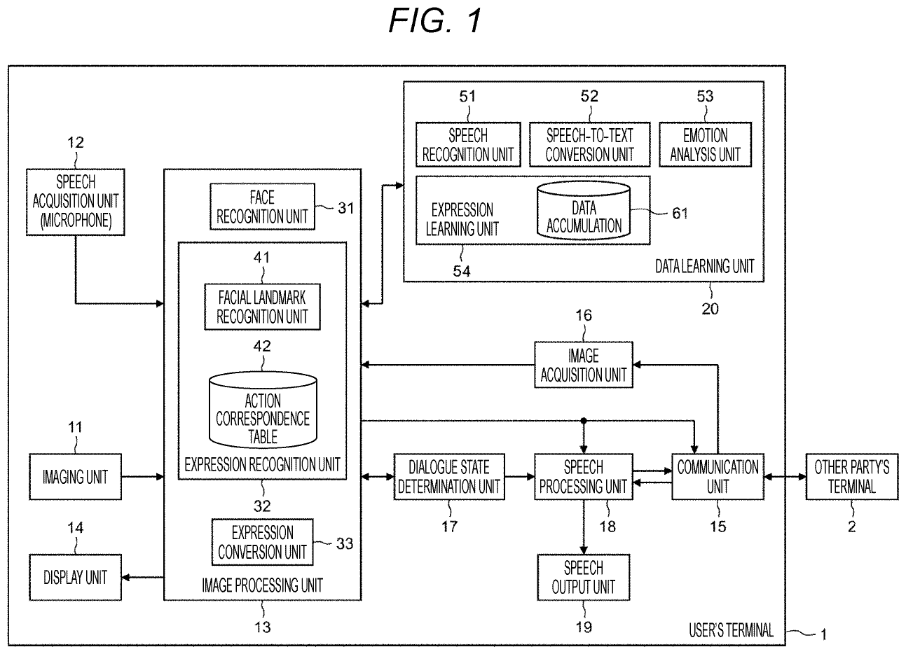

FIG. 1 is a block diagram illustrating an example configuration of an information processing system according to an embodiment to which the present technology is applied.

In FIG. 1, an information processing system data processing system according to the present embodiment includes terminals 1 and 2 such as smartphones, tablets, or personal computers (PCs), for example. In the description below, it is assumed that terminals 1 and 2 are used in a one-to-one video-chat by smartphones, for example. One of the terminals 1 and 2 is also referred to as the user's terminal 1, and the other is also referred to as the other party's terminal 2. As the user's terminal 1 and the other party's terminal 2, or the terminals 1 and 2, have similar configurations and can perform similar processes, the configuration of and the process to be performed by the user's terminal 1 (also simply referred to as the terminal 1) are described herein. Note that the other party's terminal 2 is only required to have a configuration for performing a video-chat with the user's terminal 1, and is not limited to any particular configuration.

The terminal 1 includes an imaging unit 11, a speech acquisition unit 12, an image processing unit 13, a display unit 14, a communication unit 15, an image acquisition unit 16, a dialog state determination unit 17, a speech processing unit 18, a speech output unit 19, and a data learning unit 20. The imaging unit 11 continuously captures a video (image) of a subject, and acquires a moving image including frames formed at predetermined time intervals. The imaging unit 11 is intended to capture an image of the face of a calling party as the subject, may be an in-camera normally provided in a smartphone or the like, for example, and captures an image of the face of the user (first calling party) of the user's terminal 1. However, the imaging unit 11 may be an out-camera, because the first calling party is captured with an out-camera in a case where an out-camera normally included in a smartphone or the like is directed to the user of the smartphone during a conversation, and a case where the photographer is different from the first calling party. That is, the imaging unit 11 may be one or a plurality of cameras included in the terminal 1, the user may designate the camera to be used as the imaging unit 11, or the camera capturing the face may be automatically switched to the imaging unit 11. The image acquired by the imaging unit 11 is supplied to the image processing unit 13.

The speech acquisition unit 12 collects voice around the terminal 1, and acquires a speech (a speech signal) as an electrical signal. The speech acquisition unit 12 may be a microphone normally included in a smartphone or the like, for example. However, the speech acquisition unit 12 may be an external device connected to the terminal 1, such as a headset or Bluetooth (registered trademark) earphones. The speech acquired by the speech acquisition unit 12 is supplied to the image processing unit 13.

The image processing unit 13 performs image processing on the image (also referred to as the user's image) supplied from the imaging unit 11 and an image (also referred to as the other party's image) from the other party's terminal 2 as supplied from the image acquisition unit 16, and supplies information (evaluation information) for determining (evaluating) a dialog state between the first calling party and the other party (also referred to as the second calling party) to the dialog state determination unit 17. Further, the image processing unit 13 generates an image for display on the basis of the user's image and the other party's image, and supplies the generated image to the display unit 14. The image for display may be in a form in which the user's image is superimposed on the other party's image, or in a form in which the other party's image and the user's image are switched, for example. Also, the image processing unit 13 supplies the speech (also referred to as the user's speech) from the user's terminal 1 as supplied from the speech acquisition unit 12 to the speech processing unit 18 and the data learning unit 20, and supplies the user's image to the communication unit 15 and the data learning unit 20. Note that the image processing unit 13 will be described later in detail.

The display unit 14 displays the image for display from the image processing unit 13. The display unit 14 may be a display normally included in a smartphone or the like, for example.

The communication unit 15 controls communication with an external device, and performs communication with the other party's terminal 2. The communication may include a wired communication network such as a local area network (LAN) or a wide area network (WAN), a wireless communication network such as a mobile communication network or a wireless local area network (WLAN), or a combined communication network, for example. The network may include the Internet using a communication protocol such as Transmission Control Protocol/Internet Protocol (TCP/IP).

The image acquisition unit 16 acquires the other party's image transmitted from the other party's terminal 2 via the communication unit 15, and supplies the acquired image to the image processing unit 13. On the basis of the evaluation information from the image processing unit 13, the dialog state determination unit 17 determines a dialog state such as the degree of dominance of the conversation in the current call. The dialog state that is the determination result is supplied to the image processing unit 13 and the speech processing unit 18. The dialog state determination unit 17 will be described later in detail.

The speech processing unit 18 acquires a speech (also referred to as the other party's speech) transmitted from the other party's terminal 2 via the communication unit 15. On the basis of the dialog state from the dialog state determination unit 17, the speech processing unit 18 performs speech processing, such as voice conversion to which a pitch shift (a change in sound pitch) or an equalizer (a voice effect) is applied, on the other party's speech. The other party's speech after the speech processing is supplied to the speech output unit 19. Further, the speech processing unit 18 can acquire the user's speech from the image processing unit 13, and perform speech processing on the user's speech on the basis of the dialog state in a manner similar to that for the other party's speech. The user's speech subjected to the speech processing is supplied to the communication unit 15, and is transmitted from the communication unit 15 to the other party's terminal 2.

The speech output unit 19 outputs the other party's speech from the speech processing unit 18 as sound waves. The speech output unit 19 may be a speaker normally included in a smartphone or the like, for example. However, the speech output unit 19 may be an external device connected to the terminal 1, such as a headset or Bluetooth (registered trademark) earphones.

The data learning unit 20 learns expressions (changes in expression) of the first calling party to add or subtract points from the degree of dominance in the conversation, on the basis of the user's image from the image processing unit 13 and the user's speech. The learning result is supplied to the image processing unit 13. The data learning unit 20 will be described later in detail.

### Details of the Image Processing Unit 13, the Dialog State Determination Unit 17, and the Speech Processing Unit 18

The image processing unit 13 includes a face recognition unit 31, an expression recognition unit 32, and an expression conversion unit 33. The face recognition unit 31 recognizes the face (face image) of the first calling party included in the user's image from the imaging unit 11. The expression recognition unit 32 recognizes an expression with respect to the face recognized by the face recognition unit 31, and, on the basis of the recognized expression, estimates the degree of dominance of the first calling party in the conversation. Note that the term “expression” includes facial movement.

The degree of dominance in the conversation indicates the degree to which each of the first calling party and the second calling party can be regarded as dominant in the dialog (conversation) between the first calling party and the second calling party. For example, it is assumed that the degree of dominance of the first calling party in the conversation becomes higher as the utterance time of the first calling party becomes longer. Also, in a case where the first calling party is not speaking, it can be regarded that the first calling party is actively participating in the conversation when “nodding (moving the neck up and down)”, listening with a smiling face (with the mouth corners raised)”, or the like. Accordingly, it is assumed that the degree of dominance of the first calling party in the conversation becomes higher as the time or the number of times when it is determined that the first calling party has shown such an active expression (reaction) as nodding, quickly responding, or doing some other habitual behavior with respect to the conversation is longer. On the contrary, in a case where the first calling party is not listening as in “the eyes are looking in some other direction (the line of sight is directed to the outside of the screen)”, or in a case where “he/she wants to talk but is unable to do so (pressing the lips)”, it can be regarded that the first calling party is not actively participating in the conversation. Note that a case where the line of sight is directed to the outside of the screen means that the line of sight is out of the direction of the display unit 14 or the imaging unit 11. It is assumed that the degree of dominance of the first calling party in the conversation becomes lower as the time or the number of times it is determined that the first calling party has showed such a negative expression (reaction) with respect to the conversation becomes longer or larger.

The expression recognition unit 32 of the image processing unit 13 can recognize the expression of the second calling party on the basis of the other party's image, and estimate the degree of dominance of the second calling party in the conversation, in a manner similar to that for the degree of dominance of the first calling party in the conversation. Note that the degree of dominance of one of the first calling party and the second calling party in the conversation may be estimated by the user's terminal 1, and the degree of dominance of the other may be estimated by the other party's terminal 2. In this case, the image processing unit 13 of the user's terminal 1 can acquire both the degree of dominance of the first calling party in the conversation and the degree of dominance of the second calling party in the conversation, by acquiring, through communication, the degree of dominance in the conversation estimated by the other party's terminal 2.

It is assumed that values are added to or subtracted from the degrees of dominance in the conversation under the same conditions (by the same evaluation method) for the first calling party and the second calling party. For example, the degrees of dominance of the first calling party and the second calling party in the conversation are represented by x1 and x2, respectively. It is assumed that, every time the first calling party or the second calling party speaks for one second, one is added to the degree of dominance x1 or x2 of the corresponding calling party in the conversation, and, every time the first calling party or the second calling party makes one quick response, one is added to the degree of dominance x1 or x2 of the corresponding calling party in the conversation. In this case, the value indicated by the degree of dominance x1 or x2 of one of the first calling party and the second calling party in the conversation is the value indicating the time or the number of times during or at which he/she has actively participated (or is regarded as having participated) in the conversation in the period from the start of the conversation to the current point of time. Therefore, to be exact, the degree of dominance x1 or x2 does not directly indicate the degree to which each of the first calling party and the second calling party can be regarded as dominating the conversation. The parameters x1 and x2 referred to as the degrees of dominance are now referred to as conversation participation evaluation values x1 and x2 for the sake of convenience, and the respective degrees of dominance of the first calling party and the second calling party are represented by the parameters X1 and X2. In that case, the degree of dominance X1 may be the value obtained according to x1/(x1+x2), and the degree of dominance X2 may be the value obtained according to x2/(x1 +x2). That is, the degrees of dominance X1 and X2 are values indicating the ratios of them, and may be the constituent ratios of the respective conversation participation evaluation values x1 and x2 with respect to the total number (sum) of the conversation participation evaluation values x1 and x2.

The expression recognition unit 32 estimates the degree of dominance X1 (or the conversation participation evaluation value x1) of the first calling party in the conversation and the degree of dominance X2 (or the conversation participation evaluation value x2) of the second calling party in the conversation, and supplies the result to the dialog state determination unit 17.

The dialog state determination unit 17 compares the degree of dominance X1 of the first calling party in the conversation with the degree of dominance X2 of the second calling party in the conversation as supplied from the expression recognition unit 32, and determines whether or not there is a difference between them. Whether or not there is a difference between the degree of dominance X1 and the degree of dominance X2 can be determined by whether or not the difference between the degree of dominance X1 and the degree of dominance X2 is equal to or greater than a predetermined critical value, for example. The critical value may be a value that is set or changed by the user (first calling party), or may be a fixed value. For example, in a case where the degree of dominance X1 and the degree of dominance X2 are expressed in percentage, when C % (C being 60, for example) is set as the critical value, the dialog state determination unit 17 determines whether or not the difference between the degree of dominance X1 and the degree of dominance X2 is C % or larger. Alternatively, the dialog state determination unit 17 may determine whether or not the degree of dominance X1 is (50−C/2) % or lower, or (50+C/2) % or higher, or may determine whether or not only one of the conditions is satisfied. For example, in a case where the first calling party is a person who is not good at speaking but likes to listen, the critical value C may be set to a relatively large value such as 60%, and, in that case, a check may be made to determine whether or not the degree of dominance X1 of the first calling party in the conversation is (50−60/2)=20% or lower. The result of determination (determination result) made by the dialog state determination unit 17 is supplied to the image processing unit 13 and the speech processing unit 18.

In a case where a determination result indicating that there is a difference between the degree of dominance X1 of the first calling party in the conversation and the degree of dominance X2 of the second calling party in the conversation is supplied from the dialog state determination unit 17, the expression conversion unit 33 of the image processing unit 13 changes the expression of the second calling party in the other party's image by image processing, and guides them to reduce the difference. The other party's image in which the expression of the second calling party is changed by the image processing is the display image that is displayed on the display unit 14 and is visually recognized by the first calling party. For example, in a case where a determination result indicating that the degree of dominance X1 is excessively lower than the degree of dominance X2 and that there is a difference between them is supplied, the expression conversion unit 33 changes the expression of the second calling party so that the degree of dominance X1 of the first calling party in the conversation becomes higher. As a specific example, the expression conversion unit 33 performs conversion to raise the mouth corners in the face image of the second calling party in the other party's image. As a result, the face of the second calling party looks more smiling, and the positive feeling increases. Thus, the first calling party is guided to increase the utterance amount (the degree of dominance X1). In a case where a determination result indicating that the degree of dominance X1 is excessively higher than the degree of dominance X2 and that there is a difference between them is supplied, the expression conversion unit 33 changes the expression of the second calling party so that the degree of dominance X1 of the first calling party in the conversation decreases. As a specific example, the expression conversion unit 33 performs conversion to lower the mouth corners in the face image of the second calling party in the other party's image. As a result, the negative feeling increases as an impression received from the face of the second calling party, and thus, the first calling party is guided to reduce the utterance amount (the degree of dominance X1).

Further, in a case where a determination result indicating that there is a difference between the degree of dominance X1 of the first calling party in the conversation and the degree of dominance X2 of the second calling party in the conversation is supplied from the dialog state determination unit 17, the expression conversion unit 33 can also change the expression of the first calling party in the user's image from the imaging unit 11 by image processing, and guide them to reduce the difference. In this case, the user's image in which the expression of the first calling party is changed by the image processing is the display image that is displayed on the display unit of the other party's terminal 2 through communication and is visually recognized by the second calling party. For example, in a case where a determination result indicating that the degree of dominance X1 is excessively lower than the degree of dominance X2 and that there is a difference between them is supplied, the expression conversion unit 33 changes the expression of the first calling party so that the degree of dominance X2 of the second calling party in the conversation decreases. In a case where a determination result indicating that the degree of dominance X1 is excessively higher than the degree of dominance X2 and that there is a difference between them is supplied, the expression conversion unit 33 changes the expression of the first calling party so that the degree of dominance X2 of the second calling party in the conversation increases.

Note that one the changing of the expression of the first calling party in the user's image and the changing of the expression of the second calling party in the other party's image may be performed by the user's terminal 1, and the other may be performed by the other party's terminal 2. The other party's terminal 2 may not have such a function of changing expressions in some cases, or the user's terminal 1 may change only the expression on one side in some cases. In the present embodiment, for ease of explanation, it is assumed that the user's terminal 1 has a function of changing only the expression of the second calling party in the other party's image with the expression conversion unit 33.

In a case where a determination result indicating that there is a difference between the degree of dominance X1 of the first calling party in the conversation and the degree of dominance X2 of the second calling party in the conversation is supplied from the dialog state determination unit 17, the speech processing unit 18 changes the voice quality of the other party's speech from the other party's terminal 2 by speech processing such as voice conversion to which a pitch shift or an equalizer (voice effect) is applied, and guides them to reduce the difference. The other party's speech whose voice quality is changed by the speech processing is a speech that is output by the speech output unit 19 and is listened to by the first calling party. For example, in a case where a determination result indicating that the degree of dominance X1 is excessively lower than the degree of dominance X2 and that there is a difference between them is supplied, the speech processing unit 18 changes the voice of the second calling party (the voice quality of the other party's speech) so that the degree of dominance X1 of the first calling party in the conversation increases. As a specific example, the speech processing unit 18 performs voice conversion for raising the pitch (sound pitch) of the other party's speech. As a result, the voice of the second calling party sounds more positive than his/her usual voice, and thus, the first calling party is guided to increase the utterance amount (the degree of dominance X1). In a case where a determination result indicating that the degree of dominance X1 is excessively higher than the degree of dominance X2 and that there is a difference between them is supplied, the speech processing unit 18 changes the voice of the second calling party (the voice quality of the other party's speech) so that the degree of dominance X1 of the first calling party in the conversation decreases. As a specific example, the speech processing unit 18 performs voice conversion to lower the pitch of the other party's speech. As a result, the voice of the second calling party sounds more negative than his/her usual voice, the first calling party is guided to reduce the utterance amount (the degree of dominance X1).

Further, in a case where a determination result indicating that there is a difference between the degree of dominance X1 of the first calling party in the conversation and the degree of dominance X2 of the second calling party in the conversation is supplied from the dialog state determination unit 17, the speech processing unit 18 can also change the voice quality of the user's speech from the speech acquisition unit 12 by speech processing, and guide them to reduce the difference. In this case, the user's speech whose voice quality is changed by the speech processing is the speech that is output from the speech output unit of the other party's terminal 2 through communication and is listened to by the second calling party.

For example, in a case where a determination result indicating that the degree of dominance X1 is excessively lower than the degree of dominance X2 and that there is a difference between them is supplied, the speech processing unit 18 changes the voice quality of the user's speech so that the degree of dominance X2 of the second calling party in the conversation decreases. In a case where a determination result indicating that the degree of dominance X1 is excessively higher than the degree of dominance X2 and that there is a difference between them is supplied, the speech processing unit 18 changes the voice quality of the user's speech so that the degree of dominance X2 of the second calling party in the conversation increases.

Note that one of the changing of the voice quality of the other party's speech and the changing of the voice quality of the user's speech may be performed by the user's terminal 1, and the other may be performed by the other party's terminal 2. The other party's terminal 2 may not have such a function of changing voice in some cases, and the user's terminal 1 may change only the voice quality of the speech on one side in some cases. In the present embodiment, for ease of explanation, it is assumed that the user's terminal 1 has a function of changing only the voice quality of the other party's speech with the speech processing unit 18.

### Details of the Expression Recognition Unit 32

The expression recognition unit 32 recognizes the expression of the face of the first calling party on the basis of the user's image from the imaging unit 11, and estimates the degree of dominance of the first calling party in the conversation (the conversation participation evaluation value x1) on the basis of the recognized expression. Note that, on the basis of the other party's image from the other party's terminal 2, the expression recognition unit 32 can estimate the degree of dominance of the second calling party in the conversation (the conversation participation evaluation value x2) in a manner similar to that for the degree of dominance of the first calling party in the conversation (the conversation participation evaluation value x1). In the present embodiment, however, the degree of dominance of the second calling party in the conversation is supplied from the other party's terminal 2, and explanation thereof is not made herein.

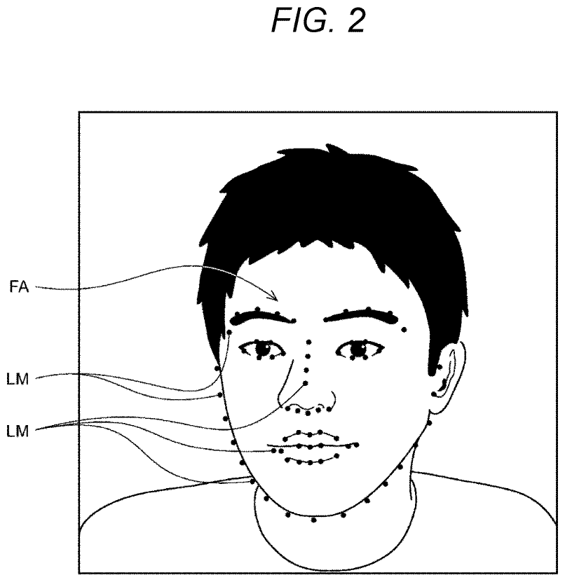

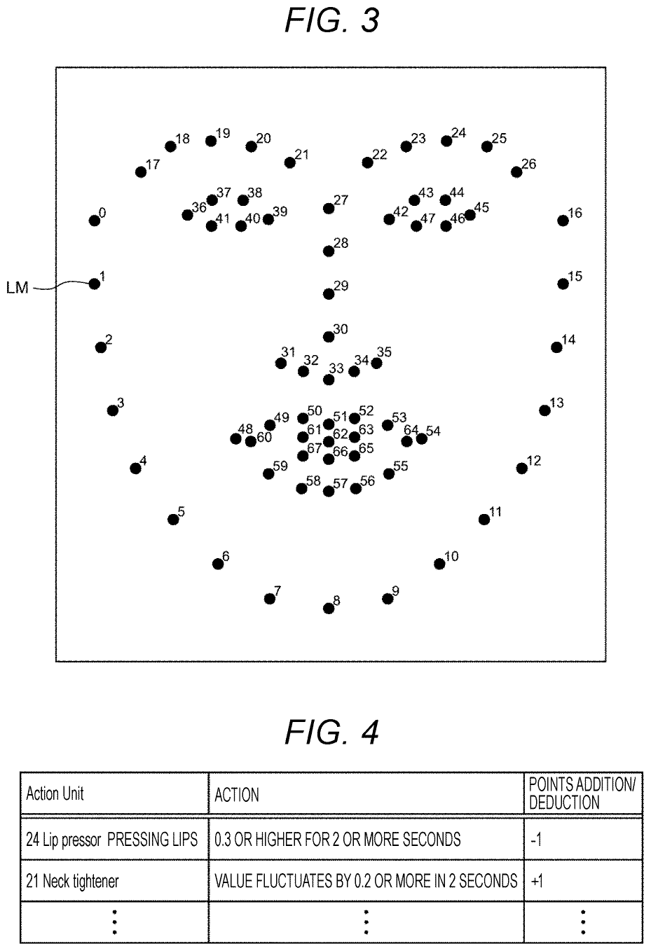

The expression recognition unit 32 includes a facial landmark recognition unit 41 and an action correspondence table 42. The facial landmark recognition unit 41 detects (recognizes) facial landmarks, to recognize the expression of the face of the first calling party in the user's image. As illustrated in FIG. 2, facial landmarks LM indicate feature points detected from a face image FA, and, as illustrated in FIG. 3, indicate 68 feature points, for example. The detection of the facial landmarks LM can be performed with “Openfece”, which is a face recognition application (Tadas Baltrusaitis, Peter Robinson, Louis-Philippe Morency, “OpenFace: an open source facial behavior analysis toolkit”, 2016 IEEE Winter Conference on Applications of Computer Vision (WACV), pp. 1-10, 2016). Also, the detection of the facial landmarks LM can be performed with a function of an application such as “ARFaceAnchor” (https://developer.apple.com/documentation/arkit/arfaceanchor), which is an application that is used in a mobile terminal such as a smartphone or a tablet, or can be performed with an inference model generated by a machine learning technology. Taking a case where “ARFaceAnchor” is used as an example, the facial landmark recognition unit 41 can acquire the degree of opening of the mouth as a coefficient called jawOpen while detecting the facial landmarks, and acquire various states of the facial landmark as coefficients, such as 1.0 when the mouth is open to the fullest and 0 when the mouth is not open at all. Since it is necessary for the first calling party to move the mouth to speak, in a case where the state of the mouth has changed, the facial landmark recognition unit 41 determines that the first calling party is in a speaking state, on the basis of the states of the facial landmarks. For example, the facial landmark recognition unit 41 increments the value of the degree of dominance of the first calling party in the conversation (the conversation participation evaluation value x1) by 1, every time the time during which the first calling party is determined to be in a speaking state lasts for one second, for example.

Also, the facial landmark recognition unit 41 detects an expression action of the first calling party from a change in the facial landmarks LM. Expression actions are indicated by a combination of expression action elements (44 kinds, for example) called an Action Unit (AU), which is the minimum unit of expression actions. The action correspondence table 42 specifies a condition for determining an active expression action from which the first calling party is regarded as actively participating in the conversation even in a case where the first calling party is not speaking, and a condition for determining a passive expression action from which the first calling party can be regarded as not actively participating in the conversation. Further, the action correspondence table 42 specifies the values to be added or subtracted with respect to the degree of dominance of the first calling party in the conversation (the conversation participation evaluation value x1) in cases where the expression actions corresponding to those specified conditions are detected. FIG. 4 shows an example of the action correspondence table 42. In a case where an expression action is detected with the use of “OpenFace”, for example, the facial landmark recognition unit 41 can acquire the coefficients for the respective Action Units. The coefficients for the respective Action Units correspond to the ratios of the expression actions of the respective Action Units included in expression actions of the first calling party. The facial landmark recognition unit 41 acquires the coefficients for the respective Action Units as detection of an expression action of the first calling party, and detects an expression action that satisfies a condition among the expression actions in the action correspondence table 42 as illustrated in FIG. 4, on the basis of the acquired coefficients for the respective Action Units.

For example, in a case where the coefficient of the expression action of the Action Unit “pressing lips” is 0.3 or higher, and the action continues for two seconds or longer, it is detected that the expression action condition indicated in the first row in FIG. 4 is satisfied. At this point of time, the facial landmark recognition unit 41 subtracts “1” from the degree of dominance of the first calling party in the conversation (the conversation participation evaluation value x1), as specified in FIG. 4. That is, it is determined that the action is a passive expression action from which the first calling party can be regarded as not actively participating in the conversation, and “1” is subtracted from the degree of dominance of the first calling party in the conversation (the conversation participation evaluation value x1).

On the other hand, in a case where the coefficient of the expression action of an Action Unit called “Neck tightener” changes by 0.2 or more in two seconds, it is detected that the condition for the expression action shown in the second row in FIG. 4 is satisfied. At this point of time, the facial landmark recognition unit 41 adds “1” to the degree of dominance of the first calling party in the conversation (the conversation participation evaluation value x1), as specified in FIG. 4. That is, it is determined that the action is an active expression action from which the first calling party can be regarded as actively participating in the conversation, and “1” is added to the degree of dominance of the first calling party in the conversation (the conversation participation evaluation value x1). Such data in the action correspondence table 42 may be created in advance in some cases, or may be learned during a conversation and be added depending on the characteristics of the expression action of the first calling party in some cases.

### Creation of Data in the Action Correspondence Table 42

A case where the data in the action correspondence table 42 is learned during a conversation and is added depending on the characteristics of the expression action of the first calling party is now described. In FIG. 1, the data learning unit 20 operates in a case where a sound component other than the human voice (the speech voice of the first calling party) included in the user's speech acquired by the speech acquisition unit 12 is at a predetermined level or lower. The data learning unit 20 includes a speech recognition unit 51, a speech-to-text conversion unit 52, an emotion analysis unit 53, and an expression learning unit 54.

The speech recognition unit 51 acquires the user's speech acquired by the speech acquisition unit 12 via the image processing unit 13, recognizes (extracts) the human voice (speech voice) from the acquired user's speech, and supplies the human voice to the speech-to-text conversion unit 52. The speech-to-text conversion unit 52 converts the speech voice from the speech acquisition unit 12 into text, and supplies the text data to the emotion analysis unit 53. The emotion analysis unit 53 detects an emotion based on the meaning of the text as emotion information on the basis of the text data from the speech-to-text conversion unit 52, and supplies the emotion information to the expression learning unit 54.

The expression learning unit 54 learns the emotion information from the emotion analysis unit 53, and the movement of the facial landmarks in the user's image of the time when the emotion information was detected. The information about the facial landmarks in the user's image is supplied from the expression recognition unit 32 (the facial landmark recognition unit 41) of the image processing unit 13 to the expression learning unit 54. As a result, the expression learning unit 54 can learn the expression action performed by the first calling party with respect to the emotion of the first calling party indicated by the emotion information, and associate the expression action of the first calling party with the emotion of the first calling party at that time. For example, in a case where the first calling party utters a word of a negative emotion such as “It was so hard” after moving his/her mouth, it is possible to associate the expression action of moving the mouth with an emotion that is negative. As for an expression action in the case of a positive emotion, a point (+1, for example) is added to the degree of dominance of the first calling party in the conversation (the conversation participation evaluation value x1). As for an expression action in the case of a negative emotion, a point (−1, for example) is subtracted from the degree of dominance of the first calling party in the conversation (the conversation participation evaluation value x1). In this manner, the data in the action correspondence table 42 can be generated. The generated data is accumulated in a data accumulation unit 61, and is put into a usable state as the data in the action correspondence table 42 of the expression recognition unit 32 at an appropriate timing.

### Processing Procedures for Adjusting the Degree of Dominance of the User's Terminal 1 in a Conversation

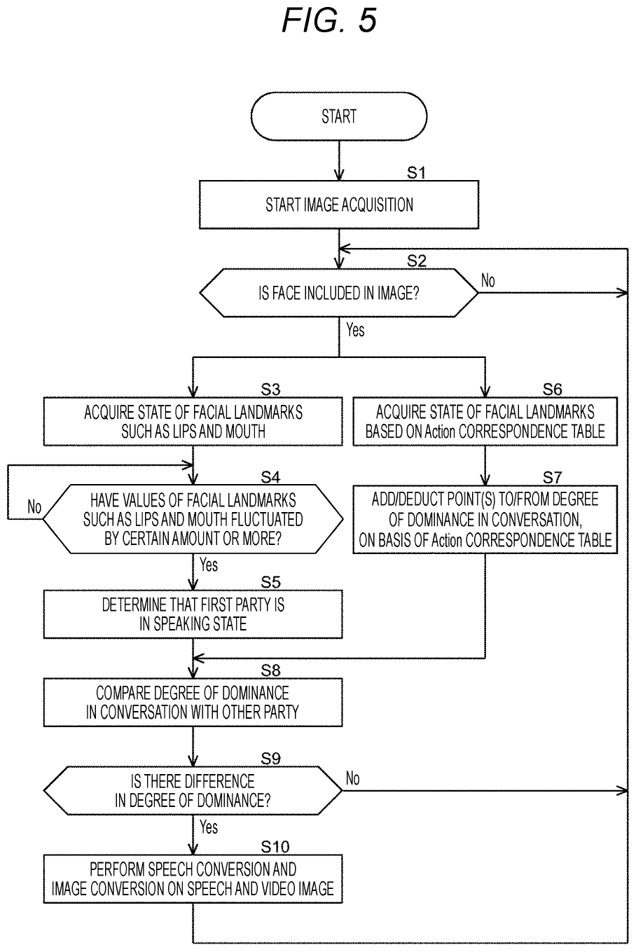

FIG. 5 is a flowchart illustrating an example of processing procedures to be carried out by the user's terminal 1. Note that the process to be performed by the data learning unit 20 to create the data in the action correspondence table 42 is not explained herein.

In step S1, the imaging unit 11 starts acquiring the user's image. After that, the acquisition of the user's image is continuously performed. In step S2, the image processing unit 13 (the face recognition unit 31) determines whether or not the face is included in the user's image acquired in step S1. If the result in step S2 is negative, the process in step S2 is repeated. If the result in step S2 is positive, the process moves on to steps S3 and S6. Note that the process in steps S3 to S5 and the process in steps S6 and S7 are performed in parallel.

In step S3, the image processing unit 13 (the facial landmark recognition unit 41 of the expression recognition unit 32) detects the facial landmarks of the first calling party in the user's image, and detects the states of the facial landmarks of the lips and the mouth. In step S4, the image processing unit 13 (the facial landmark recognition unit 41 of the expression recognition unit 32) determines whether or not the values (coordinates) of the facial landmarks of the lip and mouth have changed by a certain value or more. If the result in step S4 is negative, the process in step S4 is repeated. If the result in step S4 is positive, the process moves on to step S5. In step S5, the image processing unit 13 (the facial landmark recognition unit 41 of the expression recognition unit 32) determines that the first calling party is in a speaking state.

At this point of time, the image processing unit 13 (the facial landmark recognition unit 41 of the expression recognition unit 32) increases the degree of dominance of the first calling party in the conversation (the conversation participation evaluation value x1). For example, the image processing unit 13 adds “1” to the degree of dominance of the first calling party in the conversation (the conversation participation evaluation value x1), or increases the duration (the number of seconds) of detection of the speaking state.

In step S6, the image processing unit 13 (the facial landmark recognition unit 41 of the expression recognition unit 32) acquires the state of the facial landmarks based on the action correspondence table 42 (the expression action of the first calling party corresponding to a condition specified in the action correspondence table 42). In step S7, the image processing unit 13 (the facial landmark recognition unit 41 of the expression recognition unit 32) performs the addition or subtraction corresponding to the expression action acquired in step S6 on the degree of dominance of the first calling party in the conversation (the conversation participation evaluation value x1), on the basis of the action correspondence table 42. In step S8, the dialog state determination unit 17 compares the degree of dominance X1 of the first calling party in the conversation with the degree of dominance X2 of the second calling party in the conversation.

In step S9, the dialog state determination unit 17 determines whether or not there is a difference between the degree of dominance X1 of the first calling party in the conversation and the degree of dominance X2 of the second calling party in the conversation. If the result in step S9 is negative, the processes starting from step S2 are repeated. If the result in step S9 is positive, the process moves on to step S10. In step S10, the image processing unit 13 (the expression conversion unit 33) converts the expression of the second calling party in the other party's image so as to reduce the difference between the degree of dominance X1 of the first calling party in the conversation and the degree of dominance X2 of the second calling party in the conversation. Also, the speech processing unit 18 converts the voice quality of the other party's speech so as to reduce the difference between the degree of dominance X1 of the first calling party in the conversation and the degree of dominance X2 of the second calling party in the conversation. Note that only one of the expression conversion by the image processing unit 13 and the voice quality conversion by the speech processing unit 18 is performed in some cases. After step S10, the process returns to step S2, and the processes starting from step S2 are repeated.

According to the present technology described above, it is possible to estimate a degree of dominance in a conversation by taking into consideration facial expression reactions such as nodding, quickly responding, and doing some other habitual behavior, instead of determining which of the first calling party (a conversation participant) and the second calling party (the other participant) is speaking more actively on the basis of simple amounts of conversation (utterance amounts). Further, in a case where a degree of dominance is determined only from an image, the accuracy becomes lower when a different camera is used at a different distance, or the subject is facing sideways. However, the states of facial landmark are used, and thus, the influence of the position and direction of the face on the accuracy is small.

Furthermore, in a video-chat in which there are the teaching side and the side to be taught through the video-chat, such as an online consultation or an online lesson, there might be few utterances from the side to be taught, or only the teaching side might keep talking. In such a situation, the user wants to talk but always listens, or cannot ask what he/she wants to ask, and, as a result, the user's satisfaction level drops. Further, there also are services for introducing places such as online campus tours, and there are cases where one side (or both dies) introduce the site using a video-chat while being outdoors. In such a case, it is also conceivable to have a video-chat in an external environment with a lot of noise.

According to the present technology, these problems are solved, and the conversation bias a one-to-one video call is solved. When the state and the situation of the user are estimated from a face image, and it is determined that there is a bias in the conversation, the conversation bias is eliminated by a user feedback. In a case where outdoor use is assumed, the user situation is determined from an image, not from voice. A conversation bias is determined from the value of a degree of dominance. A degree of dominance in a conversation is calculated by adjusting the degree of dominance with an expression reaction, in addition to a speaking state. Thus, even if the speech on one side occupies most of the conversation, it is difficult to determine that the conversation is biased in a case where the non-speaking side often nods or responds.

### Embodiments (Use Cases)

The information processing system illustrated in FIG. 1 and others can adopt the following embodiments.

### First Embodiment

In a service such as an online consultation or an online lesson, a mode in which the information processing system automatically selects the other side is possible. Alternatively, in a service for selecting an optimal conversation partner such as a matching service, it is conceivable to perform matching based on the degrees of dominance in a conversation. As for the tendencies of the degrees of dominance in a conversation, persons having opposite tendencies, or a person having a high degree of dominance in the conversation and a person having a low degree of dominance in the conversation are automatically matched, so that the person who wants to talk can talk a lot and be satisfied, and the person who does not want to talk a lot does not need to talk a lot and can be satisfied.

### Second Embodiment

In the first embodiment, simple amounts of conversation (utterance amounts) are used. However, as an application method, it is also possible to perform matching based on not only the degrees of dominance in the conversation but also the actions in the action correspondence table in such a manner that a person who frequently looks at the other party (a person who looks at the call screen) is matched with a person who makes a large number of reactions without any problem, and a person who hardly looks at the other party is matched with a person who hardly makes a reaction without any problem.

### Third Embodiment

In addition to the above, by providing a parameter indicating that the voice is easy to hear because a person who opens his/her mouth wide to have a conversation opens his/her mouth clearly (a person whose average value of a specific coefficient of mouth opening is high), it is possible to consider an application method for training or education of a high-quality host, using a matching service or conversation proficiency as an index in such a service.

### Example Configuration of a Computer

The above-described series of processes can be performed by hardware or software. In a case where the series of processes is performed by software, a program that forms the software is installed into a computer. Here, examples of the computer include a computer incorporated into dedicated hardware, a general-purpose personal computer that can execute various functions by having various programs installed thereinto, and the like.

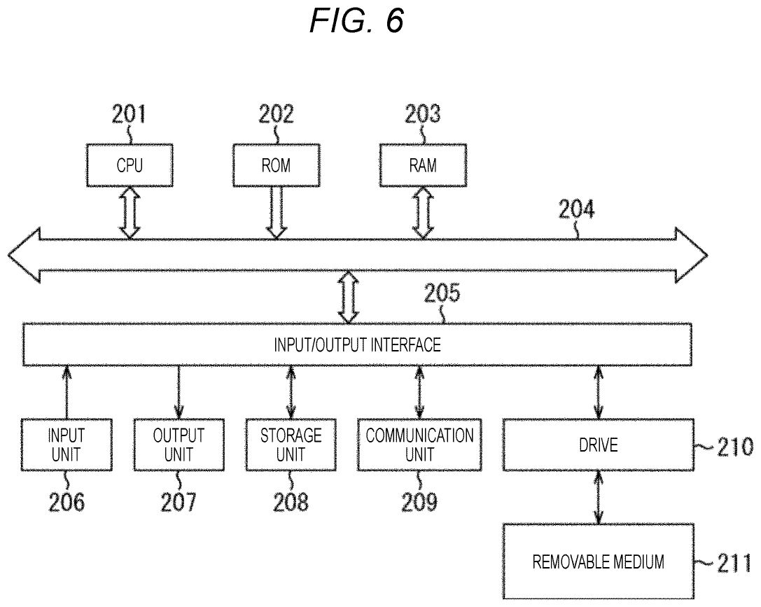

FIG. 6 is a block diagram illustrating an example configuration of the hardware of a computer that performs the above-described series of processes in accordance with a program.

In the computer, a central processing unit (CPU) 201, a read only memory (ROM) 202, and a random access memory (RAM) 203 are connected to one another by a bus 204.

An input/output interface 205 is further connected to the bus 204. The input/output interface 205 is connected to an input unit 206, an output unit 207, a storage unit 208, a communication unit 209, and a drive 210.

The input unit 206 includes a keyboard, a mouse, a microphone, and the like. The output unit 207 includes a display, a speaker, and the like. The storage unit 208 includes a hard disk, a nonvolatile memory, and the like. The communication unit 209 includes a network interface and the like. The drive 210 drives a removable medium 211 such as a magnetic disk, an optical disk, a magneto-optical disk, or a semiconductor memory.

In the computer configured as described above, the CPU 201 loads the program stored in the storage unit 208 into the RAM 203 via the input/output interface 205 and the bus 204, for example, and executes the program, to perform the above-described series of processes.

The program to be executed by the computer (CPU 201) can be provided by being recorded as a packaged medium or the like on the removable medium 211, for example. Also, the program can be provided via a wired or wireless transmission medium such as a local area network, the Internet, or digital satellite broadcasting.

In the computer, the program can be installed into the storage unit 208 via the input/output interface 205 when the removable medium 211 is set in the drive 210. Also, the program can be received by the communication unit 209 via a wired or wireless transmission medium, and be installed into the storage unit 208. Alternatively, the program may be installed beforehand into the ROM 202 or the storage unit 208.

Note that the program to be executed by the computer may be a program for performing the processes in the chronological order according to the sequence described herein, or may be a program for performing the processes in parallel or at necessary timing such as when a call is made.

Here, the processes to be performed by the computer in accordance with the program are not necessarily performed in the chronological order according to the sequence shown as the flowchart. In other words, the processes to be performed by the computer in accordance with the program includes processes to be performed in parallel or independently (parallel processing or object-oriented processing, for example).

Further, the program may be executed by a single computer (processor), or may be executed in a distributed manner by a plurality of computers. Further, the program may be transferred to a distant computer, and be executed there.

Moreover, in the present specification, a system means a set of a plurality of components (devices, modules (parts), and the like), and it does not matter whether or not all the components are in the same housing. Therefore, a plurality of devices housed in different housings and connected to one another through a network, and a single device including a plurality of modules housed in a single housing are both systems.

Also, a component described as one device (or processing unit) may be divided and formed as a plurality of devices (or processing units), for example Conversely, components described above as a plurality of devices (or processing units) may be collectively formed as one device (or processing unit).

Furthermore, a component other than the above-described components may be added to the configuration of each device (or each processing unit). Further, as long as the configuration and operation of the entire system are substantially the same, part of the configuration of a certain device (or processing unit) may be included in the configuration of some other device (or some other processing unit).

Further, the present technology can be embodied as cloud computing in which one function is shared and processed in a distributed manner by a plurality of devices through a network, for example.

Also, the program described above can be executed by any desired device, for example. In that case, the device is only required to have necessary functions (functional blocks or the like), and obtain necessary information.

Further, each step of the flowchart described above can be carried out by a single device, or can be carried out by a plurality of devices in a shared manner, for example. Moreover, in a case where a single step includes a plurality of processes, the plurality of processes included in the single step can be performed by a single device or be executed by a plurality of devices in a shared manner. In other words, the plurality of processes included in a single step can also be performed as processes in a plurality of steps. Conversely, processes described as a plurality of steps can be collectively performed as a single step.

Note that, in the program to be executed by the computer, the processes in steps in which the program is written may be performed in chronological order according to the sequence described herein, or may be performed in parallel or independently at a necessary timing such as when a call is made. That is, as long as there is no contradiction, the processes in the respective steps may be performed in a different sequence from the above-described sequence. Further, the processes in the steps in which the program is written may be performed in parallel with processes according to some other program, or may be performed in combination with processes according to some other program.

Note that the multiple techniques according to the present technology that has been described herein can be implemented independently of each other, as long as there is no contradiction. It goes without saying that any multiple techniques according to the present technology can be implemented in combination. For example, some or all of the present technology described in any of the embodiments can be implemented in combination with some or all of the present technology described in the other embodiments. Furthermore, some or all of the above-described present technology can be implemented in combination with some other technology not described above.

### Example Combinations of Configurations

Note that the present technology may also have the following configurations.
(1)

An information processing apparatus including
a processing unit that estimates a degree of dominance of a participant in a conversation, on the basis of a face image of the participant participating in the conversation.
(2)

The information processing apparatus according to (1), in which
the processing unit estimates the degree of dominance of the participant, on the basis of an expression action of the participant.
(3)

The information processing apparatus according to (2), in which
the processing unit detects the expression action of the participant on the basis of a facial landmark detected from the face image.
(4)

The information processing apparatus according to (3), in which
the processing unit detects the expression action of the participant from a combination of expression action elements.
(5)

The information processing apparatus according to any one of (1) to (4), in which
the processing unit estimates the degree of dominance, on the basis of an expression action of the participant of a time when the participant is speaking, and an expression action of the participant of a time when the participant is not speaking, the expression actions being recognized on the basis of the face image.
(6)

The information processing apparatus according to any one of (1) to (5), in which
the processing unit acquires a degree of dominance of the other participant in the conversation, the other participant participating in the conversation, and
estimates the degree of dominance of the participant as a value indicating a ratio to the degree of dominance of the other participant.
(7)

The information processing apparatus according to (5), in which,
when the expression action of the participant of the time when the participant is not speaking is an expression action from which the participant is regarded as actively participating in the conversation, the processing unit increases the degree of dominance of the participant.
(8)

The information processing apparatus according to (7), in which,
when the expression action of the participant is nodding, quickly responding, or smiling, the processing unit determines that the expression action of the participant is an expression action from which the participant is regarded as actively participating in the conversation.
(9)

The information processing apparatus according to any one of (5) to (8), in which,
when the expression action of the participant of the time when the participant is not speaking is an expression action from which the participant is regarded as not actively participating in the conversation, the processing unit lowers the degree of dominance of the participant.
(10)

The information processing apparatus according to (9), in which,
when the expression action of the participant is an expression action of pressing lips, or when a line of sight is out of a direction of the imaging unit capturing the face image, the expression action of the participant is determined to be an expression action from which the participant is regarded as not actively participating in the conversation.
(11)

The information processing apparatus according to any one of (1) to (10), further including:
a display unit that displays a face image of the other participant participating in the conversation; and
a conversion unit that changes part of the face image of the other participant displayed on the display unit in accordance with the degree of dominance of the participant in the conversation, to convert an expression of the other participant.
(12)

The information processing apparatus according to (11), in which
the conversion unit changes a mouth corner in the face image of the other participant.
(13)

The information processing apparatus according to any one of (1) to (12), in which
the conversion unit changes part of the face image of the participant or the other participant, to make the degree of dominance of the participant satisfy a preset condition.
(14)

The information processing apparatus according to any one of (1) to (13), further including:
a speech output unit that outputs a speech of the other participant participating in the conversation; and
a speech processing unit that changes voice quality of the speech of the other participant output from the speech output unit, in accordance with the degree of dominance of the participant in the conversation.
(15)

The information processing apparatus according to (14), in which
the speech output unit changes voice quality of the speech of the other participant by adopting a pitch shift or an equalizer.
(16)

The information processing apparatus according to any one of (1) to (15), in which
the speech processing unit changes voice quality of a speech of the participant or the other participant, to make the degree of dominance of the participant satisfy a preset condition.
(17)

The information processing apparatus according to any one of (1) to (16), in which
the processing unit matches the participant with the other participant participating in the conversation, in accordance with the degree of dominance of the participant.
(18)

The information processing apparatus according to (17), in which,
regarding a tendency of the degree of dominance, the processing unit performs matching between the participant and the other participant whose tendency is opposite from the tendency of the participant, the other participant participating in the conversation.
(19)

An information processing method implemented by a processing unit of an information processing apparatus, the information processing method including:
estimating a degree of dominance of a participant in a conversation, on the basis of a face image of the participant participating in the conversation.
(20)

A program for causing a computer to function as:
a processing unit that estimates a degree of dominance of a participant in a conversation, on the basis of a face image of the participant participating in the conversation.

Note that the present embodiment is not limited to the embodiments described above, and various modifications can be made to them without departing from the scope of the present disclosure. Furthermore, the effects described herein are merely examples and are not restrictive, and some other effects may be achieved.

### REFERENCE SIGNS LIST

1 User's terminal
2 Other party's terminal
11 Imaging unit
12 Speech acquisition unit
13 Image processing unit
14 Display unit
15 Communication unit
16 Image acquisition unit
17 Dialog state determination unit
18 Speech processing unit
19 Speech output unit
20 Data learning unit
31 Face recognition unit
32 Expression recognition unit
33 Expression conversion unit
41 Facial landmark recognition unit
42 Action correspondence table
51 Speech recognition unit
52 Speech-to-text conversion unit
53 Emotion analysis unit
54 Expression learning unit
61 Data accumulation unit

1. An information processing apparatus comprising
a processing unit that estimates a degree of dominance of a participant in a conversation, on a basis of a face image of the participant participating in the conversation.

2. The information processing apparatus according to claim 1, wherein
the processing unit estimates the degree of dominance of the participant, on a basis of an expression action of the participant.

3. The information processing apparatus according to claim 2, wherein
the processing unit detects the expression action of the participant on a basis of a facial landmark detected from the face image.

4. The information processing apparatus according to claim 3, wherein
the processing unit detects the expression action of the participant from a combination of expression action elements.

5. The information processing apparatus according to claim 1, wherein
the processing unit estimates the degree of dominance, on a basis of an expression action of the participant of a time when the participant is speaking, and an expression action of the participant of a time when the participant is not speaking, the expression actions being recognized on a basis of the face image.

6. The information processing apparatus according to claim 1, wherein
the processing unit acquires a degree of dominance of another participant in the conversation, the another participant participating in the conversation, and
estimates the degree of dominance of the participant as a value indicating a ratio to the degree of dominance of the another participant.

7. The information processing apparatus according to claim 5, wherein,
when the expression action of the participant of the time when the participant is not speaking is an expression action from which the participant is regarded as actively participating in the conversation, the processing unit increases the degree of dominance of the participant.

8. The information processing apparatus according to claim 7, wherein,
when the expression action of the participant is nodding, quickly responding, or smiling, the processing unit determines that the expression action of the participant is an expression action from which the participant is regarded as actively participating in the conversation.

9. The information processing apparatus according to claim 5, wherein,
when the expression action of the participant of the time when the participant is not speaking is an expression action from which the participant is regarded as not actively participating in the conversation, the processing unit lowers the degree of dominance of the participant.

10. The information processing apparatus according to claim 9, wherein,
when the expression action of the participant is an expression action of pressing lips, or when a line of sight is out of a direction of the imaging unit capturing the face image, the expression action of the participant is determined to be an expression action from which the participant is regarded as not actively participating in the conversation.

11. The information processing apparatus according to claim 1, further comprising:
a display unit that displays a face image of another participant participating in the conversation; and
a conversion unit that changes part of the face image of the another participant displayed on the display unit in accordance with the degree of dominance of the participant in the conversation, to convert an expression of the another participant.

12. The information processing apparatus according to claim 11, wherein
the conversion unit changes a mouth corner in the face image of the another participant.

13. The information processing apparatus according to claim 1, wherein
the conversion unit changes part of the face image of the participant or the another participant, to make the degree of dominance of the participant satisfy a preset condition.

14. The information processing apparatus according to claim 1, further comprising:
a speech output unit that outputs a speech of the another participant participating in the conversation; and
a speech processing unit that changes voice quality of the speech of the another participant output from the speech output unit, in accordance with the degree of dominance of the participant in the conversation.

15. The information processing apparatus according to claim 14, wherein
the speech output unit changes voice quality of the speech of the another participant by adopting a pitch shift or an equalizer.

16. The information processing apparatus according to claim 1, wherein
the speech processing unit changes voice quality of a speech of the participant or the another participant, to make the degree of dominance of the participant satisfy a preset condition.

17. The information processing apparatus according to claim 1, wherein
the processing unit matches the participant with the another participant participating in the conversation, in accordance with the degree of dominance of the participant.

18. The information processing apparatus according to claim 17, wherein,
regarding a tendency of the degree of dominance, the processing unit performs matching between the participant and the another participant whose tendency is opposite from the tendency of the participant, the another participant participating in the conversation.

19. An information processing method implemented by a processing unit of an information processing apparatus, the information processing method comprising:
estimating a degree of dominance of a participant in a conversation, on a basis of a face image of the participant participating in the conversation.

20. A program for causing a computer to function as:
a processing unit that estimates a degree of dominance of a participant in a conversation, on a basis of a face image of the participant participating in the conversation.
